(19) United States
(12) Patent Application Publication
(10) Pub. No.: US 2022/0378234 A1
(43) Pub. Date: Dec. 1, 2022

(54) WOOD VENEER BEVERAGE CONTAINER SLEEVE

(71) Applicant: Kevin T. PARADIS, Ashland, ME (US)

(72) Inventor: Kevin T. PARADIS, Ashland, ME (US)

(21) Appl. No.: 17/329,471

(22) Filed: May 25, 2021

(51) Int. Cl. A47G 23/02; B65D 81/38; B67B 7/18

(52) U.S. Cl. CPC A47G 23/0216; B65D 81/3876; B67B 7/18; A47G 2023/0291

(57) ABSTRACT

A beverage container sleeve made from two-ply rolled wood veneer, having an ovoid open end, an internal cavity, and a circular closed base, whereby the outer surface of the device may have printed thereon an aesthetic design and the base may have formed into its underside a bottle cap removing component; and a method for manufacturing same.

### BACKGROUND OF THE INVENTION

The present invention relates to beverage container sleeves, and specifically to beverage container sleeves made of wood veneer.

Beverage container sleeves are well known in the art. Known variously as “koozies”, “coosies”, “stubby holders”, “beer sleeves”, or “beer jackets”, these devices are cylindrical in shape, with a substantially closed bottom and an open top, and are configured to retain a beverage container, such as a bottle or a can, therein. Originally created to provide a layer of insulation around the beverage container, primarily to keep the container's contents cold for a longer period of time, as well as to provide a barrier keeping condensation from the container away from the hand of the person holding the container, these devices quickly evolved into promotional items, bearing logos, slogans, and other promotional materials on the outer surface. The need for the devices to be insulating receded and was supplanted by the aesthetic value they provided. Beverage container sleeves also often became seen as disposable items.

Most beverage container sleeves are typically made of foam, which provides the insulating properties originally sought, and which is also a low cost material facilitating mass production. The role of beverage container sleeves evolving into promotional devices, as free giveaways, for example, requires that costs be kept as low as possible. The foam construction causes the device to be quite flexible, facilitating packing them in a flattened shape for easy shipping; it also results in the inner foam surface creating a high degree of friction with the outer surface of the beverage container, making insertion and extraction of the container difficult. Forcing a container into the constricted inner cavity of a foam device also creates a semi vacuum, whereby air in the cavity is forced out as the container is forced in; this further makes extraction of the container difficult. Some beverage container sleeves have apertures formed into their bottom panels, thereby breaking the vacuum, but the frictional forces between the inner surface of the device and the outer surface of the container remain an issue.

Notwithstanding the low cost imperative of most beverage container sleeves, there is a market for more aesthetically pleasing and longer lasting beverage container sleeves. These may be made of costlier materials, or combinations of materials. One such premium material is wood. Wooden beverage container sleeves are known in the art. These are typically created from a solid piece of wood, which is turned on a lathe or similar device to achieve the desired outer shape, and then hollowed out to create the cavity in which to receive the container. See, e.g., U .S. Pat. Appl. No. 2014/0246402A1 (Tschanen) (disclosing the use of a computer numerical control (“CNC”) machine for creating the inner cavity).

While this method is effective, it creates a substantial amount of waste when the inner cavity of the device is formed. The resulting beverage container sleeve is also relatively heavy, due to the thickness of the remaining wooden portions. Because of the rigidity of wood, unless very precise tolerances are engineered into the manufacturing process, a container may not fit into the cavity, or it may fit too loosely within the cavity. Finally, applying aesthetic designs to these devices entails etching or engraving, a costly and time consuming process, or affixing a separate design element thereto, such as a sticker or a plaque. Thus, while wooden beverage container sleeves are aesthetically pleasing, the known art has considerable disadvantages.

It is therefore shown that an improved premium beverage container sleeve is needed, in which the beverage container sleeve is constructed of premium materials in an efficient manner in which aesthetic enhancements can be easily added.

Thus, it is an object of the present invention is to provide a premium beverage container sleeve constructed primarily of wood veneer.

It is a further object of the present invention to provide a beverage container sleeve that can be manufactured in an efficient manner with minimal waste.

It is yet a further object of the present invention to provide a beverage container sleeve in which aesthetic enhancements can be easily added.

It is yet a further object of the present invention to provide a beverage container sleeve that can easily accommodate a container within its cavity without need for exacting tolerances.

It is yet a further object of the present invention to provide a beverage container sleeve that allows for easy extraction of a container from its cavity.

It is yet a further object of the present invention to provide a beverage container sleeve that is light weight.

It is yet a further object of the present invention to provide a method of manufacture of a wood veneer beverage container sleeve.

Other objects of the present invention will be readily apparent from the description that follows.

### SUMMARY

The present invention is a beverage container sleeve constructed from wood. It has a vertical wall and a base, with an open upper end, an internal cavity, and a substantially closed lower end created by the base. The vertical wall of the sleeve is constructed of a wood veneer, and the base of the sleeve is constructed preferably of wood, though other materials can also be used.

The vertical wall of the sleeve is formed by rolling two plies of veneer into a substantially cylindrical shape, affixing the plies to each other with an adhesive, and then adding a substantially circular base to the bottom of the vertical wall. The use of two plies of veneer allows for a more expensive veneer to be used for the outer surface of the sleeve and for a thicker, less expensive veneer to be used for the core and inner surface of the sleeve, thereby providing premium aesthetics at a reduced cost. In addition, the thinner outer veneer is capable of being inserted into a standard printer, thereby allowing any type of aesthetic text and graphic to be easily and inexpensively added to the outer surface.

In the preferred embodiment the vertical wall of the sleeve has a slightly ovoid cross section at its upper opening. This ovoid cross section becomes more circular towards the middle and substantially circular at the base. The advantage of the ovoid open upper end is that a certain amount of flexion is present in the upper end of the sleeve, to more easily accommodate the container. Additionally, because of the ovoid perimeter, only a portion of the upper open end of the sleeve contacts the outer surface of the container, reducing the frictional forces between the inner surface of the sleeve and the outer surface of the container, thus allowing for easier insertion while still holding the container secure. Exact tolerances are therefore not required. The slight gaps created by the ovoid shape also prevent a vacuum from forming when the container is inserted, thereby making extraction easier.

Optionally, a bottle cap remover is formed into the outer surface of the base.

Optionally, one or more apertures are formed through the base, providing a means for draining moisture that may accumulate within the sleeve.

A method for constructing the beverage container sleeve of the present invention is also disclosed. The method comprises the steps of obtaining all raw materials, preparing the veneer for vertical wall assembly, forming the vertical wall from the veneer, inserting the base into the lower portion of the vertical wall and affixing thereto, and finishing the product.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

### DESCRIPTION OF THE DRAWINGS

FIG. 1A is a plan side view of one embodiment of the beverage container sleeve of the present invention, depicting said sleeve with a container inserted therein.

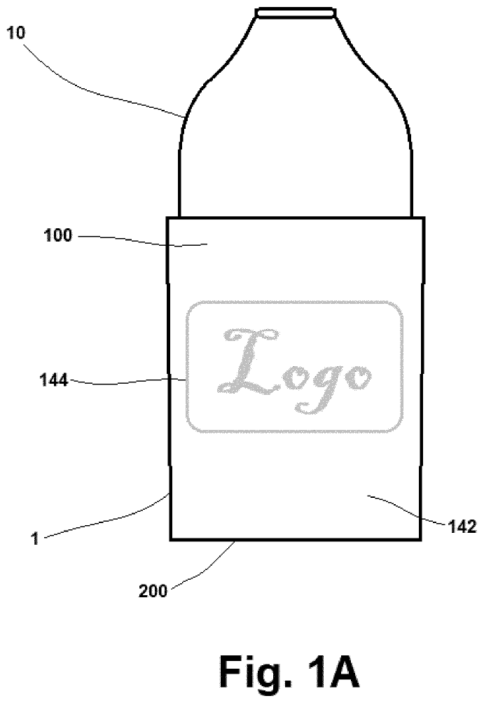

FIG. 1B is a plan side cutaway view of the embodiment of the beverage container sleeve shown in FIG. 1A.

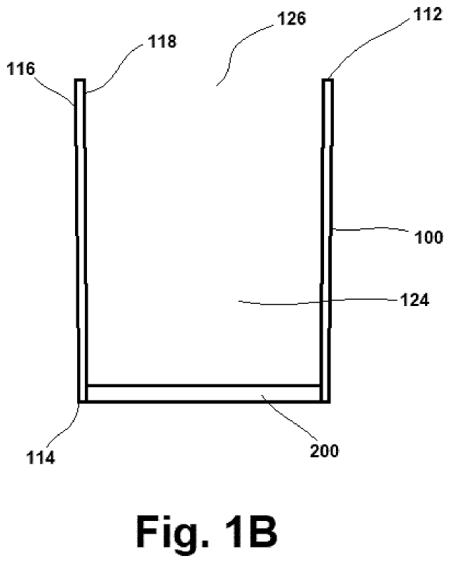

FIG. 2A is a plan top view of an embodiment of the beverage container sleeve of the present invention.

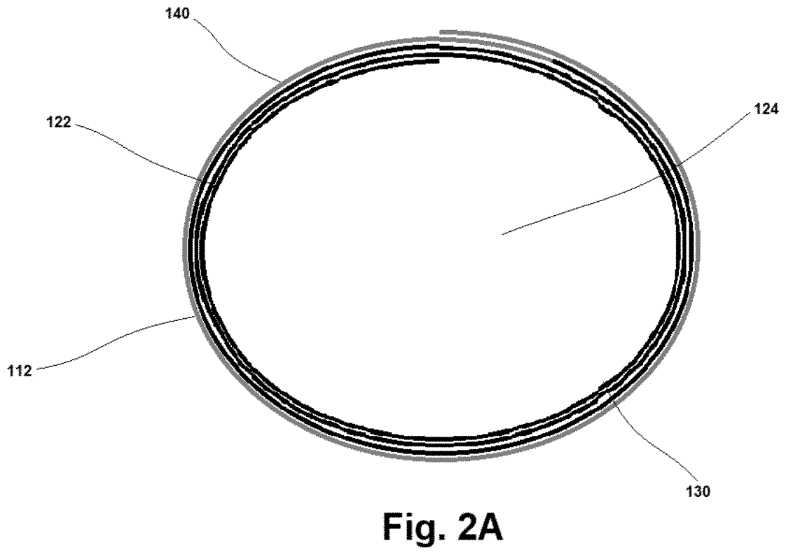

FIG. 2B is a plan bottom view of the embodiment of the beverage container sleeve of the present invention shown in FIG. 2A.

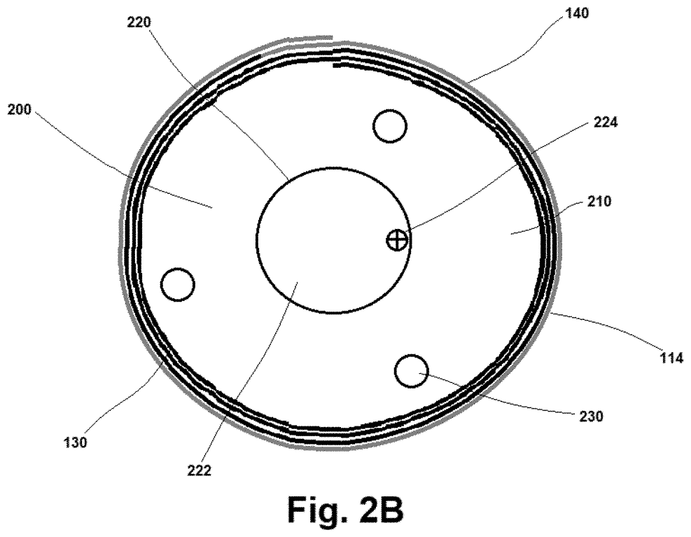

### DETAILED DESCRIPTION OF THE INVENTION

The present invention is a beverage container sleeve 1 for use with a beverage container 10. The beverage container 10 is any standard container having a substantially circular cross section, such as a bottle or a can. The beverage container sleeve 1 comprises a vertical wall 100 and a base 200.

The vertical wall 100 of the beverage container sleeve 1 is substantially cylindrical. It has an upper edge 112, a lower edge 114, an outer surface 116, an inner surface 118, and a core 122. The upper edge 112 has a perimeter having a substantially ovoid shape. The lower edge 114 has a perimeter having a substantially circular shape. The vertical wall 100 therefore has a variable-shaped cross-section, which changes from substantially oval to substantially circular from the upper edge 112 to the lower edge 114.

The vertical wall 100 defines an inner cavity 124 and an upper opening 126. The inner cavity 124 is configured to receive the lower portion of a container 10; the lower portion of the container 10 is placed through the upper opening 126 of the vertical wall 100 and into the inner cavity 124. The oval shape of the perimeter of the upper edge 112 of the vertical wall 100 provides contact points between the inner surface 118 of the vertical wall 100 and the outer surface of the container 10, but not all portions of the inner surface 118 of the vertical wall 100 are in contact with the outer surface of the container 10. Specifically, the portions of the vertical wall 100 which lie proximate to the ends of the short axis of the oval describing the perimeter of the upper edge 112 of the vertical wall 100 are in contact with the outer surface of the container 10, and the portions of the vertical wall 100 which lie proximate to the ends of the long axis of the oval describing the perimeter of the upper edge 112 of the vertical wall 100 are not in contact with the outer surface of the container 10. This creates a gap between at least portions of the inner surface 118 of the vertical wall 100 and the outer surface of the container 10, facilitating insertion of the container 10 into and extraction of the container 10 from the beverage container sleeve 1.

The vertical wall 100 is formed of a first ply 130 and a second ply 140. The first ply 130 is a sheet of wood veneer, and the second ply 140 is a sheet of wood veneer. Both plies 130,140 are substantially rectangular in shape, with the first and second plies 130,140 having substantially the same widths, but with the first ply 130 having a greater length than the second ply 140. The first ply 130 is also thicker than the second ply 140. The first and second plies 130,140 are bonded together with an adhesive, thereby forming the vertical wall 100 of the beverage container sleeve 1.

The larger, thicker first ply 130 made be made of less expensive, inferior veneer. It comprises the core 122 and inner surface 118 of the vertical wall 100. The smaller, thinner second ply 140 is preferably made from a premium wood veneer having superior aesthetic properties. It comprises the outer surface 116 of the vertical wall 100. The thinness of the second ply 140 allows it to be placed in a standard printer, thereby allowing any manner of text, design, or other ornamentation 144 to be quickly and easily printed onto the outer surface 142 of the second ply 140. Because the first ply 130 is thicker than the second ply 140, a shorter length is required to form a suitably rigid core 122 for the vertical wall 100. In contrast, if a thinner ply were used, it would have to be longer and be coiled multiple times about itself in order to create a rigid core, requiring more veneer as well as more adhesive to hold the extra coils together, thereby increasing costs. Also, by using two plies, the more expensive premium veneer second ply 140 need have only a minimal length, thereby further saving costs. In the preferred embodiment, the first ply 130 has a length long enough to be coiled at least two times, and preferably up to four times, thereby forming the inner surface 118 and the core 122 of the vertical wall 100. This may be between 15 and 24 inches, with a preferred length of 18 inches. The second ply 140 has a length just long enough to completely encircle the outer perimeter of the vertical wall 100. This may be between 8 inches and 12 inches, with a preferred length of 10 inches, though slight deviations from this range are also contemplated. The second ply 140 is bonded to the first ply 130 by use of an adhesive during manufacture. The adhesive is also applied to portions of the first ply 130 as it is coiled onto itself to form the substantially cylindrical shape of the vertical wall 100, bonding to itself in layers.

The base 200 of the beverage container sleeve 1 is substantially planar and substantially circular and configured to be placed into the inner cavity 124 of the vertical wall 100 proximate to the lower edge 114 of the vertical wall 100, and affixed thereto. The base 200 may be made of any suitable material, with the preferred material being wood. This may be solid wood, plywood, composite wood, or the like.

The base 200 may comprise an optional bottle cap removal device 220. The bottle cap removal device 220 is formed into the underside 210 of the base 200, creating a cavity 222, said cavity 222 being substantially circular and having a substantially uniform depth, with that depth being less than the thickness of the base 200. The inside diameter of the cavity 222 should be just slightly larger than the outside diameter of a standard bottle cap, or about 1⅛ inches. A protuberance 224 is placed into the cavity 222 proximate to a side wall of the cavity 222. The protuberance 224 serves as a point of leverage for the underside of the lip of the bottle cap. In one embodiment the protuberance 224 may be a flat head screw.

The base 200 may further comprise one or more optional apertures 230. The apertures 230 are formed completely through the thickness of the base 200, thereby providing drainage for any moisture that may accumulate within the inner cavity 124 of the vertical wall 100.

The beverage container sleeve 1 of the present invention may be dimensioned to any suitable size, to accommodate standard 12 ounce soda cans, narrower beer cans, domestic beer bottles, imported beer bottles, and the like. The layered construction of the vertical wall 100 of the beverage container sleeve 1 results in a substantially rigid device with a limited amount of flex proximate to its top edge. This flex allows for easier insertion of the beverage container 10 into, and removal from, the beverage container sleeve 1. The manufacturing process also avoids the excess waste of traditional wooden koozies, which must discard up to 90% of the wood when hollowing out the inner cavity 124.

One method of manufacture of the beverage container sleeve 1 of the present invention is hereby disclosed.

Step A: obtain a first ply 130 having a substantially rectangular shape, a width, a length, and a thickness, said first ply 130 made of wood veneer;

Step B: obtain a second ply 140 having a substantially rectangular shape, a width, a length, and a thickness, said width of the second ply 140 being substantially the same as the width of the first ply 130, said length of the second ply 140 being less than the length of the first ply 130, and said thickness of the second ply 140 being less than the thickness of the first ply 130, said second ply 140 made of wood veneer;

Step C: obtain an adhesive suitable for bonding said first ply 130 to itself and said second ply 140 to said first ply 130;

Step D: obtain a base 200, said base 200 being substantially planar and having a substantially circular shape and a substantially uniform thickness;

Step E: place the second ply 140 adjacent to the first ply 130, temporarily securing it thereto, and roll the plies 130,140 over a form to create a vertical wall 100 of the beverage container sleeve 1, beginning with the first ply 130 and finishing with the second ply 140, simultaneously applying the adhesive to the first and second plies 130,140 as they are rolled;

Step F: allow the vertical wall 100 of the beverage container sleeve 1 to harden and dry; and

Step G: insert the base 200 into a lower portion of the vertical wall 100 of the beverage container sleeve 1 and affix it thereto with adhesive;

whereby Steps A, B, C, and D may be performed in any order; Step E is performed after Steps A, B, C, and D; Step F is performed after Step E; and Step G is performed after Step F.

Another method of manufacture of the beverage container sleeve 1 of the present invention is hereby disclosed:

Step 1: Obtain the following raw materials:
a. A first ply 130 of wood veneer having approximately a 1/16″ thickness
b. A second ply 140 of wood veneer having a thickness of between 1/38″ and 1/42″ and a face grade veneer
c. A section of dimensioned approximately 3½″×3½″ lumber for the base 200
d. Wood glue to be used as an adhesive
e. A ¾″ wood screw having a flat underside for the bottle cap remover
f. Stain for prepping the veneer plies 130,140
g. Semi-gloss finish for finishing the veneer plies 130,140
h. Masking tape
i. Paint or colored stain

Step 2: Prepare the veneers for vertical wall 100 creation
a. Cut the first ply 130 to the following dimension: approximately 18″ long by 7″ wide.
b. Taper both sides of the first ply 130 with a sander, with a resulting target thickness to match the thickness of the second ply 140
c. Stain the second ply 140
d. Dry the second ply 140 thoroughly
e. Create an image 144 to print onto the second ply 140
f. Add humidity to the second ply 140, with a target range of 9-12% moisture
g. Insert the second ply 140 into a printer and print the image 144 onto the second ply 140, feeding the second ply 140 through the printer like card stock
h. Allow the printed image 144 to dry

Step 3: Make the vertical wall 100
a. Obtain a form having an oval shaped cross-section, with the long axis of the oval being between ¼″ to ⅜″ longer than the short axis of the oval
b. Tape the unprinted side of the second ply 140 to the end of the first ply 130
c. Align veneers square to the form
d. Tape the first ply 130 to the form
e. Apply wood glue to the leading edge of the first ply 130
f. Begin rolling the veneers onto the form
g. Spread wood glue onto the veneers as the first ply 130 and then the second ply 140 are rolled onto the form
h. Wrap the vertical wall 100 in paper to prevent the veneers from unrolling and allow to dry for approximately 30 to 60 minutes
i. Remove the vertical wall 100 from the form
j. Allow the wood glue to thoroughly dry
k. Remove the binding paper from the vertical wall 100
l. Apply a finish coat to the outside of the vertical wall 100
m. Cut to length and sand edges

Step 4: Make the base 200
a. Cut the dimensioned lumber to the desired thickness:
   a1. Bottle version: approximately ⅞″ thick
   a2. Can version: approximately ⅜″ thick
b. Cut the dimensioned lumber into a circle
c. Drill a hole through the center of the base 200 (approximately 5/32 ″ in diameter)
d. Optionally, add a bottle cap remover: using a 1½″ Forstner bit, drill a concave partial hole in the center of the base 200 to a depth of about 7/16″, add a single ¾″ screw in the concave portion just below the flush point of the bottom and offset it to one side
e. Smooth the outer edges of the base 200 so that it can snugly fit inside the vertical wall 100
f. Paint or stain the base 200

Step 5: Assembly/Finish
a. Glue the base 200 inside the bottom of the vertical wall 100 with wood glue, with the optional concave portion oriented outward for bottle cap removal device 220
b. Apply finish to both sides of the base 200 and to the inner surface 118 of the vertical wall 100
c. Allow to dry

Modifications and variations can be made to the disclosed embodiments of the present invention without departing from the subject or spirit of the invention.

1. A beverage container sleeve for use with a beverage container, said beverage container having a substantially circular cross section, said beverage container sleeve comprising
a vertical wall and a base,
wherein said vertical wall is substantially cylindrical, having an upper edge, a lower edge, an outer surface, a core, and an inner surface, with the upper edge having a perimeter with a substantially ovoid shape and the lower edge having a perimeter with a substantially circular shape, said vertical wall defining an inner cavity and an upper opening, said vertical wall formed of a first ply and a second ply, said first ply being constructed of wood veneer and said second ply being constructed of wood veneer, with said first ply having a thickness and said second ply having a thickness less than the thickness of the first ply, said second ply bonded to said first ply by use of an adhesive, said second ply comprising the outer surface of the vertical wall and said first ply comprising the core and the inner surface of the vertical wall; and
the base is substantially planar and substantially circular and configured to be placed into the inner cavity of the vertical wall proximate to the lower edge of the vertical wall and affixed thereto.

2. The beverage container sleeve of claim 1 wherein the second ply is made of a premium veneer having superior aesthetic properties as compared to the first ply.

3. The beverage container sleeve of claim 1 wherein the second ply has an outer surface upon which an image is printed.

4. The beverage container sleeve of claim 1 wherein the base is affixed to the vertical wall by an adhesive.

5. The beverage container sleeve of claim 1 wherein the base is constructed of wood.

6. The beverage container sleeve of claim 1 wherein the base has a substantially uniform thickness and further comprises a bottle cap removal device.

7. The beverage container sleeve of claim 6 wherein the bottle cap removal device is a substantially circular cavity formed into an underside of the base, said cavity having a substantially uniform depth less than the thickness of the base, said bottle cap removal device further comprising a protuberance, said protuberance being located in the cavity proximate to a side wall of the cavity.

8. The beverage container sleeve of claim 1 wherein the base has a substantially uniform thickness and further comprises one or more apertures, each said aperture formed completely through the thickness of the base.

9. The beverage container sleeve of claim 1 wherein the vertical wall and the base are stained.

10. The beverage container sleeve of claim 1 wherein the vertical wall and the base are coated with a semi-gloss finish.

11. A method for manufacturing a beverage container sleeve for use with a beverage container, said beverage container having a substantially circular cross section, said method comprising the following steps:
Step A: obtain a first ply having a substantially rectangular shape, a width, a length, and a thickness, said first ply made of wood veneer;
Step B: obtain a second ply having a substantially rectangular shape, a width, a length, and a thickness, said width of the second ply being substantially the same as the width of the first ply, said length of the second ply being less than the length of the first ply, and said thickness of the second ply being less than the thickness of the first ply, said second ply made of wood veneer;
Step C: obtain an adhesive suitable for bonding said first ply to itself and said second ply to said first ply;
Step D: obtain a base, said base being substantially planar and having a substantially circular shape and a substantially uniform thickness;
Step E: place the second ply adjacent to the first ply, securing it thereto;
Step F: roll the first and second plies over a form, beginning with the first ply and finishing with the second ply, simultaneously applying the adhesive to the first and second plies as they are rolled, to create a vertical wall of the beverage container sleeve;
Step G: allow the vertical wall of the beverage container sleeve to dry and harden; and
Step H: insert the base into a lower portion of the vertical wall of the beverage container sleeve and affix it thereto;
whereby Steps A, B, C, and D may be performed in any order; Step E is performed after Steps A and B; Step F is performed after Steps C and E; Step G is performed after Step F; and
Step H is performed after Steps D and G.

12. The method of claim 11 wherein the base of Step D is constructed of wood.

13. The method of claim 11 wherein the form of Step E has an oval cross section.

14. The method of claim 11 wherein Step E further comprises the second ply being secured to the first ply with tape.

15. The method of claim 11 wherein Step H further comprises affixing the base to the lower portion of the vertical wall of the beverage container sleeve with adhesive.

16. The method of claim 11 further comprising Step B1, wherein the second ply is placed in a printer and an image is printed upon an outer surface of the second ply;
whereby Step B1 is performed after Step B; and Step B1 is performed before Step E.

17. The method of claim 11 further comprising Step D1, wherein a bottle cap removal device is formed into an underside of the base, creating a cavity, said cavity being substantially circular and having a substantially uniform depth, with said depth being less than the thickness of the base, and having a protuberance placed into said cavity proximate to a side wall of said cavity;
whereby Step D1 is performed after Step D; and Step D1 is performed before Step H.

18. The method of claim 11 further comprising Step D2, wherein one or more apertures are formed completely through the thickness of the base;
whereby Step D2 is performed after Step D; and Step D2 is performed before Step H.

19. The method of claim 11 further comprising Step G1, wherein the vertical wall of the beverage container sleeve is removed from the form of Step E;
whereby Steps G and G1 may be performed in any order; Step G1 is performed after Step F; and Step G1 is performed before Step H.

20. The method of claim 11 further comprising Step I, wherein the vertical wall of the beverage container sleeve and the base of the beverage container sleeve are stained;
whereby Step I is performed after Step H.

21. The method of claim 11 further comprising Step J, wherein the vertical wall of the beverage container sleeve and the base of the beverage container sleeve are coated with a semi-gloss finish;
whereby Step J is performed after Step H.

22. A method for manufacturing a beverage container sleeve for use with a beverage container, said beverage container having a substantially circular cross section, said method comprising the following steps:
Step A: obtain a first ply having a substantially rectangular shape, a width, a length, and a thickness, said first ply made of wood veneer;
Step B: obtain a second ply having a substantially rectangular shape, a width, a length, and a thickness, said width of the second ply being substantially the same as the width of the first ply, said length of the second ply being less than the length of the first ply, and said thickness of the second ply being less than the thickness of the first ply, said second ply made of wood veneer;
Step C: place the second ply in a printer and print an image upon an outer surface of the second ply;
Step D: obtain an adhesive suitable for bonding said first ply to itself and said second ply to said first ply;
Step E: obtain a base, said base being substantially planar and having a substantially circular shape and a substantially uniform thickness, wherein the base is constructed of wood;
Step F: form a bottle cap removal device into an underside of the base, creating a cavity, said cavity being substantially circular and having a substantially uniform depth, with said depth being less than the thickness of the base, and having a protuberance placed into said cavity proximate to a side wall of said cavity;
Step G: form one or more apertures completely through the thickness of the base;
Step H: place the second ply adjacent to the first ply, securing it thereto with tape;
Step I: roll the first and second plies over a form, said form having an oval cross section, beginning with the first ply and finishing with the second ply, simultaneously applying the adhesive to the first and second plies as they are rolled, to create a vertical wall of the beverage container sleeve;
Step J: allow the vertical wall of the beverage container sleeve to dry and harden;
Step K: remove the vertical wall of the beverage container sleeve from the form;
Step L: insert the base into a lower portion of the vertical wall of the beverage container sleeve and affix it thereto with adhesive;
Step M: stain the vertical wall of the beverage container sleeve and the base of the beverage container sleeve; and
Step N: coat the vertical wall of the beverage container sleeve and the base of the beverage container sleeve with a semi-gloss finish;
whereby Steps A, B, D, and E may be performed in any order; Step C is performed after Step B; Steps F and G may be performed in any order; Steps F and G are performed after Step E; Step H is performed after Steps A, B, C, D, and E; Step I is performed after Step H; Steps J and K may be performed in any order; Steps J and K are performed after Step I; Step L is performed after Steps F, G, J, and K; Step M is performed after Step L; and Step N is performed after Step M.

23. The beverage container sleeve of claim 1 wherein said first ply further has a substantially rectangular shape, a width, and a length, and said second ply further has a substantially rectangular shape, a width, and a length;
whereby said width of the second ply is substantially the same as the width of the first ply, and
said length of the second ply is less than the length of the first ply.
